(19) United States
(12) Patent Application Publication
(10) Pub. No.: US 2026/0107301 A1
(43) Pub. Date: Apr. 16, 2026

(54) METHOD AND APPARATUS FOR DYNAMICALLY ADJUSTING CONFIGURATION PARAMETERS

(71) Applicant: MEDIATEK INC., Hsinchu City (TW)

(72) Inventors: Lung-Wen CHEN, Hsinchu City (TW); Yi-Han CHUNG, Hsinchu City (TW); Wan-Ting HUANG, Hsinchu City (TW)

(21) Appl. No.: 19/348,847

(22) Filed: Oct. 3, 2025

Related U.S. Application Data
(60) Provisional application No. 63/707,805, filed on Oct. 16, 2024.

(51) Int. Cl. H04W 74/02; H04L 41/0813; H04L 41/0823; H04W 64/00

(52) U.S. Cl. CPC H04W 74/02; H04L 41/0813; H04L 41/0823; H04W 64/006

(57) ABSTRACT

A method for dynamically adjusting configuration parameters is provided. The method is implemented by a user equipment (UE) and includes obtaining a current absolute speed of the UE according to current speed information. The method includes obtaining a speed level corresponding to the current absolute speed. The method includes adjusting at least one configuration parameter according to the speed level.

### CROSS REFERENCE TO RELATED APPLICATIONS

This application claims the benefit of U.S. Provisional Application No. 63/707,805, entitled “Speed Awareness UE Interoperability Enhancement”, filed on Oct. 16, 2024, the entirety of which is incorporated by reference herein.

### BACKGROUND OF THE INVENTION

### Field of the Invention

The present disclosure generally relates to wireless communication. More specifically, aspects of the present disclosure relate to a method and apparatus for dynamically adjusting configuration parameters.

### Description of the Related Art

Unless otherwise indicated herein, approaches described in this section are not prior art to the claims listed below and are not admitted as prior art by inclusion in this section.

As defined by 3GPP specifications, most configuration parameters in wireless communication systems are broadcast or otherwise configured by a Node B (or base station) toward user equipments (UEs).

The conventional approach typically determines such configurations without explicitly considering the mobility or speed of the UE. As a result, identical configurations may be applied to UEs operating at different speed levels.

For example, as illustrated in FIG. 1, a base station may broadcast the same configurations toward multiple UEs (user equipments), regardless of their mobility states. A UE that is walking, a UE that is driving, a UE that is driving on a highway, and a UE traveling on a high-speed train may all receive identical configurations. Since such configurations are not adapted to the respective speeds of the UEs, service continuity and quality may be affected. In particular, UEs moving at higher speeds (e.g., on a highway or on a high-speed train) may experience poor performance compared to UEs moving at lower speeds (e.g., walking).

Consequently, such uniform configurations may inadvertently or deliberately favor UEs of certain mobility states, which can cause variations in service quality and continuity, and may ultimately impact user experience.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and apparatus for dynamically adjusting configuration parameters. The method and apparatus for dynamically adjusting configuration parameters use pre-defined speed levels and their corresponding configurations to improve adaptability for the UEs, thereby enhancing interoperability with the network under different mobility conditions.

In an exemplary embodiment, a method for dynamically adjusting configuration parameters is provided. The method is implemented by a user equipment (UE) and includes obtaining a current absolute speed of the UE according to current speed information. The method further includes obtaining a speed level corresponding to the current absolute speed. The method further includes adjusting at least one configuration parameter according to the speed level.

In some embodiments, the method further includes performing a network access procedure according to the at least one adjusted configuration parameter.

In some embodiments, the method further includes obtaining historical speed information in an event that the current speed information is unavailable and inferring the current absolute speed according to the historical speed information.

In some embodiments, the inferring of the current absolute speed according to the historical speed information further comprises determining an average or a weighted average of the historical speed information as the current absolute speed.

In some embodiments, the inferring of the current absolute speed according to the historical speed information further comprises training a machine learning model on the historical speed information and using the machine learning model to infer the current absolute speed automatically.

In some embodiments, ranges of the current absolute speed corresponding to respective speed levels are non-uniform.

In some embodiments, the at least one configuration parameter comprises one of a random access (RA) retry time, a time-to-trigger (TTT) timer, a cell (re)selection parameter, and a reselection threshold.

In some embodiments, the at least one configuration parameter is given by a network node and is a variable value.

In some embodiments, the at least one configuration parameter is given by a wireless communication standard and is a fixed value.

In some embodiments, the at least one configuration parameter is adjusted while the UE is in an IDLE state, an INACTIVE state, or a CONNECTED state.

In an exemplary embodiment, an apparatus for dynamically adjusting configuration parameters is provided. The apparatus comprises a transceiver and a processor. The transceiver which, during operation, wirelessly communicates. The processor communicatively coupled to the transceiver such that, during operation, the processor performs operations comprising obtaining a current absolute speed of the apparatus according to current speed information. The processor performs operations comprising obtaining a speed level corresponding to the current absolute speed. The processor performs operations comprising adjusting at least one configuration parameter according to the speed level.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale, as some components may be shown out of proportion to their size in actual implementation in order to clearly illustrate the concept of the present disclosure.

FIG. 1 depicts a schematic diagram illustrating a base station broadcasting the same configuration to multiple UEs.

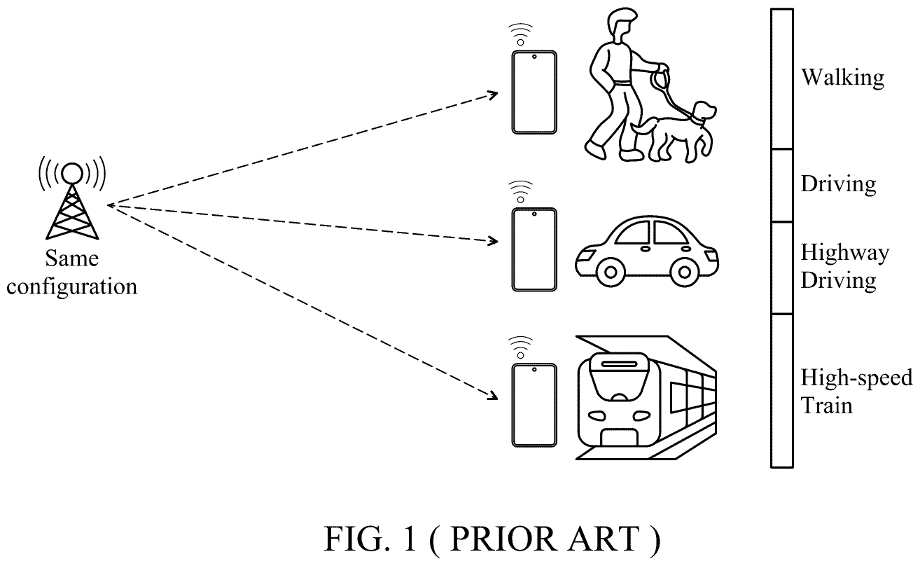

FIG. 2 is a block diagram of an example communication system in accordance with an implementation of the present disclosure.

FIG. 3 is a flowchart of an example process in accordance with an implementation of the present disclosure.

### DETAILED DESCRIPTION OF THE INVENTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not shown) by the same numerals in the example figures. However, the features in different implementations may differ in other respects, and thus shall not be narrowly confined to what is shown in the figures.

The description uses the phrases “in one implementation” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. The expression “at least one of A, B, and C” or “at least one of the following: A, B, and C” means “only A, or only B, or only C, or any combination of A, B, and C.”

Additionally, for the purposes of explanation and non-limitation, specific details, such as functional entities, techniques, protocols, standards, and the like, are set forth to provide an understanding of the described technology. In other examples, detailed descriptions of well-known methods, technologies, systems, architectures, and the like are omitted so as not to obscure the description with unnecessary details.

Persons skilled in the art will immediately recognize that any network functions or algorithms described in the present disclosure may be implemented by hardware, software, or a combination of software and hardware. Described functions may correspond to modules which may be software, hardware, firmware, or any combination thereof. The software implementation may comprise computer executable instructions stored on computer computer-readable medium, such as memory or other types of storage devices. For example, one or more microprocessors or general-purpose computers with communication processing capability may be programmed with corresponding executable instructions and carry out the described network functions or algorithms. The microprocessors or general-purpose computers may be formed of Applications Specific Integrated Circuitry (ASIC), programmable logic arrays, and/or using one or more Digital Signal Processors (DSPs). Although some of the example implementations described in this specification are oriented to software installed and executing on computer hardware, nevertheless, alternative example implementations implemented as firmware or as hardware or a combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, a 5G New Radio (NR) Radio Access Network (RAN) or a 6G NR RAN) typically includes at least one Base Station (BS), at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), or the Internet), through a RAN established by one or more BSs.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), 6G, and/or LTE-A Pro. However, the scope of the present disclosure should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a NG-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through a plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next-generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate, and low latency requirements. The Orthogonal Frequency-Division Multiplexing (OFDM) technology, as agreed in the 3rd Generation Partnership Project (3GPP), may serve as a baseline for the NR waveform. The scalable OFDM numerology, such as the adaptive sub-carrier spacing, the channel bandwidth, and the Cyclic Prefix (CP), may also be used. Additionally, two coding schemes are considered for NR: (1) Low-Density Parity-Check (LDPC) code and (2) Polar Code. The coding scheme adaptation may be configured based on the channel conditions and/or the service applications.

Moreover, it is also considered that in a transmission time interval TX of a single NR frame, a Downlink (DL) transmission data, a guard period, and an Uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects and represents that three relationships may exist. For example, A and/or B may indicate that: A exists alone, A and B exist at the same time, or B exists alone. In addition, the character “/” herein generally represents that the former and latter associated objects are in an “or” relationship.

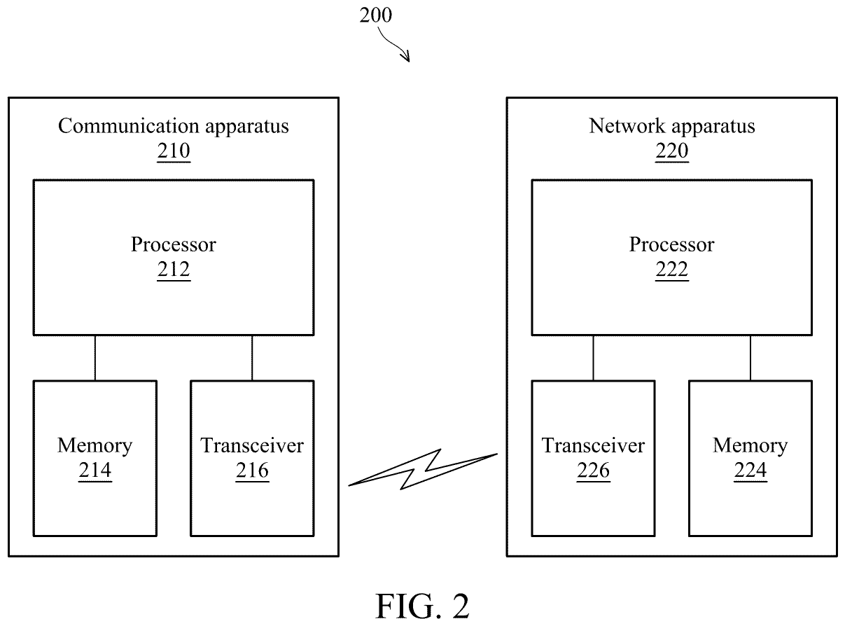

FIG. 2 illustrates an example communication system 200 having at least an example communication apparatus 210 and an example network apparatus 220 in accordance with an implementation of the present disclosure. Each of the communication apparatus 210 and network apparatus 220 may perform various functions to implement schemes, techniques, processes, and methods described herein pertaining to dynamically adjusting configuration parameters in mobile communications, including scenarios/schemes described above, as well as process 300 described below.

Communication apparatus 210 may be a part of an electronic apparatus, which may be a UE such as a portable or mobile apparatus, a wearable apparatus, a wireless communication apparatus, or a computing apparatus. For instance, communication apparatus 210 may be implemented in a smartphone, a smartwatch, a personal digital assistant, a digital camera, or a computing equipment such as a tablet computer, a laptop computer, or a notebook computer. Communication apparatus 210 may also be a part of a machine-type apparatus, which may be an IoT, NB-IoT, or IIoT apparatus, such as an immobile or a stationary apparatus, a home apparatus, a wire communication apparatus, or a computing apparatus. For instance, communication apparatus 210 may be implemented in a smart thermostat, a smart fridge, a smart door lock, a wireless speaker, or a home control center. Alternatively, communication apparatus 210 may be implemented in the form of one or more integrated-circuit (IC) chips, such as, for example, and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2, such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of a network apparatus, which may be a network node such as a satellite, a base station, a small cell, a router, or a gateway. For instance, network apparatus 220 may be implemented in an eNB in an LTE network, in a gNB in a 5G/NR, IoT, NB-IoT, or IIoT network, or in a satellite or base station in a 6G network. Network apparatus 220 may include at least some of those components shown in FIG. 2, such as a processor 222, for example. Processor 222 may further include protocol stacks and a set of control functional modules and circuits. Network apparatus 220 may further include one or more other components not pertinent to the proposed scheme of the present disclosure (e.g., internal power supply, display device, and/or user interface device), and, thus, such component(s) of network apparatus 220 are neither shown in FIG. 2 nor described below in the interest of simplicity and brevity.

In one aspect, each of the processor 212 and processor 222 may be implemented in the form of one or more single-core processors, one or more multi-core processors, or one or more CISC processors. That is, even though a singular term “a processor” is used herein to refer to processor 212 and processor 222, each of the processor 212 and processor 222 may include multiple processors in some implementations and a single processor in other implementations in accordance with the present disclosure. In another aspect, each of the processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 212 and processor 222 is a special-purpose machine specifically designed, arranged, and configured to perform specific tasks in a device (e.g., as represented by communication apparatus 210) and a network (e.g., as represented by network apparatus 220) in accordance with various implementations of the present disclosure.

In some implementations, communication apparatus 210 may also include a memory 214 coupled to processor 212 and capable of being accessed by processor 212 and storing data therein. In some implementations, communication apparatus 210 may further include a transceiver 216 coupled to processor 212 and capable of wirelessly transmitting and receiving data.

In some implementations, network apparatus 220 may further include a memory 224 coupled to processor 222 and capable of being accessed by processor 222 and storing data therein, and a transceiver 226 coupled to processor 222 and capable of wirelessly transmitting and receiving data. Accordingly, communication apparatus 210 and network apparatus 720 may wirelessly communicate with each other via transceiver 216 and transceiver 226, respectively.

For illustrative purposes and without limitation, descriptions of capabilities of the communication apparatus 210 and network apparatus 220 are provided below with process 300. In which, communication apparatus 210 is implemented in or as a communication apparatus or a UE, and network apparatus 220 is implemented in or as a network node of a communication network (e.g., a base station).

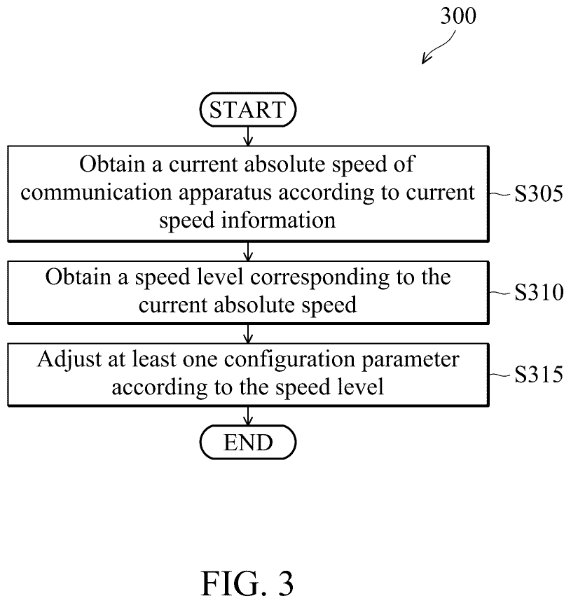

FIG. 3 illustrates an example process 300 in accordance with an implementation of the present disclosure. Process 300 may be an example implementation of the above scenarios/schemes, whether partially or completely, with respect to dynamically adjusting configuration parameters. Process 300 may represent an aspect of implementation of features of communication apparatus 210. Process 300 may include one or more operations, actions, or functions as illustrated by one or more of blocks S305, S310 and S315. Although illustrated as discrete blocks, various blocks of process 300 may be divided into additional blocks, combined into fewer blocks, or eliminated, depending on the desired implementation. Moreover, the blocks of process 300 may be executed in the order shown in FIG. 3 or, alternatively, in a different order. Process 300 may be implemented by communication apparatus 210 or any suitable UE or machine-type devices. Solely for illustrative purposes and without limitation, process 300 is described below in the context of communication apparatus 210 as a UE. Process 300 may begin at block S305.

At block S305, process 300 may involve processor 212 of communication apparatus 210 obtaining a current absolute speed of communication apparatus 210 according to current speed information, wherein the current speed information may also be measured by the inertial sensors of the UE, such as an accelerometer, or gyroscope, or determined with the aid of other navigation resources, for example, by means of Global Navigation Satellite System (GNSS) or similar radio triangulation methods. Process 300 may proceed from block S305 to block S310.

At block S310, process 300 may involve processor 212 obtaining a speed level corresponding to the current absolute speed. Specifically, the UE may obtain a speed level corresponding to the current absolute speed through a speed level table, a preset algorithm, user input, and machine learning, etc. The UE may pre-define many different speed level tables in advance for different application scenarios, and in each speed level table, the ranges of the current absolute speed corresponding to respective speed levels are non-uniform. An exemplary speed level table is shown in Table 1. It should be noted that the speed level table shown in Table 1 is not used to limit the present disclosure, and those skilled in the art can make appropriate replacements or adjustments according to this embodiment.

TABLE 1

| Speed Level | Absolute speed V (KM/hr) |
|---|---|
| 0 | 0 ≤ V < 1 |
| 1 | 1 ≤ V < 10 |
| 2 | 10 ≤ V < 50 |
| 3 | 50 ≤ V < 100 |
| 4 | 100 ≤ V < 130 |
| 5 | 130 ≤ V < 160 |
| . . . | . . . |

As illustrated in Table 1, each speed level corresponds to a respective range of the absolute speed V. It is noted that the ranges associated with the different speed levels are not uniform. For example, Speed level 0 corresponds to a narrow range of 0≤V<1, while Speed level 2 corresponds to a significantly broader range of 10≤V<50. Process 300 may proceed from block S310 to block S315.

At block S315, process 300 may involve processor 212 adjusting at least one configuration parameter according to the speed level. More specifically, for each speed level, the UE may define how the configuration parameters are adjusted for different speed levels. Depending on the nature of the configuration parameters, the adjustment methods may include, but are not limited to, the following: absolute values (e.g., for adjusting a random access retry time), scaled values (e.g., for adjusting a time to trigger (TTT) timer), offset (e.g., for adjusting a cell (re)selection parameter (Srxlev, Squal)), range-defining values (e.g., for adjusting a reselection threshold (threshServingLowP)), such as a maximum value, a minimum value, or boundary values. Table 2 shows an exemplary table of adjusting the configuration parameter P.

TABLE 2

| Speed | Absolute value | Scaled value | Offset | Range-defining value |
|---|---|---|---|---|
| level | (RA retry time) | (TTT timer) | (Srxlev, Squal) | (threshServingLowP) |
| X | — | P × (1 − Speed_{—} | P + Speed_{—} | MAX(P, Pre-defined |
| | | level) × 5% | level × 2 dB | value) |
| 0 | 3 | 320 ms | 12 | 10 |
| 1 | 3 | 304 ms | 14 | 10 |
| 2 | 2 | 228 ms | 16 | 12 |

As shown in Table 2, both the RA retry time, the TTT timer, the cell (re)selection parameter, Srxlev or Squal, and the reselection threshold, threshServingLowP, may be adaptively adjusted according to the speed level corresponding to the current absolute speed. For example, while the RA retry time remains constant at 3 for speed levels 0 and 1, the RA retry time is reduced to 2 at speed level 2. The TTT timer may be adjusted as a scaled value according to the expression P×(1−Speed_level)×5%, wherein P represents a configuration parameter given by the network node, which is a variable value. In the example in Table 2, it is assumed that P is 320 ms. When the speed level is 0, the TTT timer is 320 ms. As the speed level increases to 1 and then 2, the TTT timers are 304 ms and 228 ms, respectively. Furthermore, it is assumed that the offset value is 2 dB, the cell (re)selection parameter may be adjusted according to the expression, P+Speed_level×2 dB. Here, P represents a configuration parameter specified by a wireless communication standard, such as 3GPP standards, and is defined as a fixed value. When the speed level is 0, the scaled value is 320 ms. As the speed level increases to 1 and 2, the scaled values are 304 ms and 228 ms, respectively. The reselection threshold, threshServingLowP, may be adjusted through the range-defining value. In the example of Table 2, the reselection threshold is the maximum value of P and a pre-defined value. Here, P represents a configuration parameter specified by a wireless communication standard, such as 3GPP standards, and is defined as a fixed value. It is assumed that P is 10, and the pre-defined values corresponding to speed levels 0, 1, and 2 are 8, 10, and 12, respectively. When the speed level is 0, the reselection threshold is the maximum value, 10, of P, which is 10, and the pre-defined value, which is 8. When the speed level is 1, the reselection threshold is the maximum value, 10, since P is equal to the pre-defined value. When the speed level is 2, the reselection threshold is the maximum value, 12, of P, which is 10, and the pre-defined value, which is 12.

In some implementations, process 300 may involve processor 212 performing a network access procedure according to the at least one adjusted configuration parameter.

In some implementations, process 300 may involve processor 212 obtaining historical speed information in an event that the current speed information is unavailable. Process 300 may further involve processor 212 inferring the current absolute speed according to the historical speed information. In one embodiment, the UE may determine an average or a weighted average of the historical speed information as the current absolute speed. An exemplary historical speed information is shown in Table 3.

TABLE 3

| Timestamp (Second) | Absolute speed (km/h) |
|---|---|
| T-5 | 85 |
| T-4 | 88 |
| T-3 | 88 |
| T-2 | 90 |
| T-1 | 92 |
| T | V |

At the current time T, the absolute speed of the UE may be obtained by averaging the absolute speeds measured at a plurality of preceding timestamps. For example, referring to Table 3, the absolute speeds at timestamps T-5 through T-1 are 85 km/h, 88 km/h, 88 km/h, 90 km/h, and 92 km/h, respectively. Accordingly, the absolute speed at the current time T may be determined as the arithmetic mean of these values, i.e.,

$$V ( T ) = \frac{( 85 + 88 + 88 + 90 + 92 )}{5} = 88.6 km / h$$

Thus, in this example, the current absolute speed at the current time T is approximately 88.6 km/h.

In another example, the absolute speed at the current time T may be obtained by a weighted average of the absolute speeds measured at a plurality of preceding timestamps, wherein the weights are normalized such that the sum of all weights equals 1. Referring to Table 3, the absolute speeds at timestamps T-5 through T-1 are 85 km/h, 88 km/h, 88 km/h, 90 km/h, and 92 km/h, respectively. The absolute speed at the current time T may be expressed as:

$$V ( T ) = \text{} {w}_{T - 1} \times V ( T - 1 ) + \text{} {w}_{T - 2} \times \text{} V ( T - 2 ) + \text{} {w}_{T - 3} \times V ( T - 3 ) + \text{} {w}_{T - 4} \times V ( T - 4 ) + \text{} {w}_{T - 5} \times V ( T - 5 ) , where {w}_{T - 1} + {w}_{T - 2} + {w}_{T - 3} + {w}_{T - 4} + {w}_{T - 5} = 1$$

For example, when larger weights are assigned to more recent measurements (e.g., w₁=0.33, w₂=0.24, w₃=0.2, w₄=0.13, and w₅=0.07), then the current absolute speed at the current time Tis given as V(T)=0.33×92+0.27×90+0.20×88+0.13×88+0.07×85=90.1 km/h. In this manner, the current absolute speed at the current time T better reflects the mobility trend of the UE, as compared to a simple arithmetic average (88.6 km/h).

In another embodiment, the UE may train a machine learning model on the historical speed information and use the machine learning model to automatically infer the current absolute speed. Referring to Table 3, the absolute speed at the current time T may be inferred using the machine learning model. The absolute speeds at timestamps T-5 through T-1 may be input into the machine learning model, such as a regression model, a neural network, or a recurrent neural network (RNN), to predict the absolute speed at the current timestamp T. For instance, in one embodiment, a regression model is trained using labeled data pairs of [V(T-5), V(T-4), V(T-3), V(T-2), V(T-1)]→V(T). Once trained, the may take the observed speeds [85, 88, 88, 90, 92] as input and output a predicted absolute speed at the current time T. In this example, the regression model may output a predicted absolute speed of approximately 93 km/h. Compared to simple averaging or weighted averaging methods, the machine learning approach can capture more complex mobility patterns (e.g., acceleration or deceleration trends) and provide a more accurate estimation of the UE's absolute speed at the current time T.

In some implementations, ranges of the current absolute speed corresponding to respective speed levels are non-uniform in the speed level table.

In some implementations, the at least one configuration parameter comprises one of the following: a random access (RA) retry time, a time-to-trigger (TTT) timer, a cell (re)selection parameter, and a reselection threshold.

In some implementations, the at least one configuration parameter is given by a network node and is a variable value.

In some implementations, the at least one configuration parameter is given by a wireless communication standard and is a fixed value.

In some implementations, the at least one configuration parameter is adjusted while the UE is in an IDLE state, an INACTIVE state, or a CONNECTED state.

The following two examples illustrate how to dynamically adjust configuration parameters according to the absolute speed of the UE.

Example 1 describes the adjustment of the cell (re)selection parameter, Srxlev and Squal.

Cell selection is typically performed when a UE is under an out-of-service condition, or when the UE is in idle mode and determines whether the UE is out of service based on S-criteria. According to the 3GPP specifications, the S-criteria do not incorporate any speed-related configuration. As a result, the same S-criteria for suitable cell determination are applied to UEs regardless of their speed. However, when the S-criteria are fine-tuned by the network node for static or low-speed UEs, a high-speed UE may encounter difficulties in identifying a suitable cell, since its signal measurements may be significantly affected by the high mobility. This problem may be overcome when the UE uses the process shown in FIG. 3.

After the UE obtains the current absolute speed and the speed level table applied to the S-criteria, the UE may obtain a speed level corresponding to the current absolute speed from the speed level table. Table 4 shows the speed level table applied to the S-criteria. It should be noted that the speed level table applied to the S-criteria is not used to limit the present disclosure, and those skilled in the art can make appropriate replacements or adjustments according to this embodiment.

TABLE 4

| Speed Level | Absolute speed V (KM/hr) |
|---|---|
| 0 | 0 ≤ V < 10 |
| 1 | 10 ≤ V < 40 |
| 2 | 40 ≤ V < 70 |
| 3 | 70 ≤ V < 100 |
| 4 | 100 ≤ V < 130 |
| 5 | 130 ≤ V |

According to Table 4, the cell (re)selection parameter, Srxlev and Squal, in evaluating the S-Criteria may be adjusted based on the following formulas:

$$Srxlev = {Q}_{rxlevmeas} - ( {Q}_{rxlevmin} + {Q}_{rxlevminoffset} ) - Pcompensation - {Qoffset}_{temp} + Speed\_Level \times 2 dB$$

$$Squal = \text{} {Q}_{qualmeas} - ( {Q}_{qualmin} + {Q}_{qualminoffset} ) {Qoffset}_{temp} + Speed\_Level \times 1 dB$$

wherein Qᵣₓₗₑᵥₘₑₐₛ, Qᵣₓₗₑᵥₘᵢₙ, Q_{rxlevminoffset}, Pcompensation, Q_{offsettemp}, Q_{qualmeas}, Q_{qualmin}, Q_{qualminoffset} are parameters defined by the 3GPP specifications. As shown above, the UE may adjust the cell (re)selection parameter, Srxlev and Squal, by Speed_Level×2 dB and Speed_Level×1 dB at the end of the formulas and determine whether a target cell is suitable based on the adjusted cell (re)selection parameter. Through this adjustment, even though the UE is very fast, there is still a high probability that the UE may camp on a certain cell.

Example 2 describes the adjustment of a set of configuration parameters related to connection establishment failure (e.g., connEstFailCount_Final, connEstFailOffsetValidity_Final, and connEstFailOffset_Final).

Connection establishment is controlled by configuration parameters collectively referred to as “ConnEstFailureControl.” According to the 3GPP specifications, the ConnEstFailureControl does not incorporate any speed-related configuration. As a result, the same ConnEstFailureControl settings are applied to UEs regardless of their mobility. However, when the ConnEstFailureControl is optimized by the network node for static or low-speed UEs, a high-speed UE may encounter difficulties in establishing a connection, since its signal transmissions can be significantly affected by the high mobility. This problem may be overcome when the UE uses the process shown in FIG. 3.

After the UE obtains the current absolute speed and the speed level table applied to “ConnEstFailureControl.”, the UE may obtain a speed level corresponding to the current absolute speed from the speed level table. Table 5 shows the speed level table applied to “ConnEstFailureControl.” It should be noted that the speed level table applied to “ConnEstFailureControl” is not used to limit the present disclosure, and those skilled in the art can make appropriate replacements or adjustments according to this embodiment.

TABLE 5

| Speed Level | Absolute speed V (KM/Hr) |
|---|---|
| 0 | 0 ≤ V < 30 |
| 1 | 30 ≤ V < 50 |
| 2 | 50 ≤ V < 70 |
| 3 | 70 ≤ V < 90 |
| 4 | 90 ≤ V < 120 |
| 5 | 120 ≤ V |

According to Table 5, the set of configuration parameters related to connection establishment failure (e.g., connEstFailCount_Final, connEstFailOffsetValidity_Final, and connEstFailOffset_Final) may be adjusted based on the following formulas:

$$connEstFailCount\_Final = floor ( connEstFailCount - Speed\_Level \times 0.2 )$$

$$connEstFailOffsetValidity\_Final = connEstFailOffsetValidity * ( 1 - Speed\_Level \times 0.05 )$$

$$connEstFailOffset\_Final = connEstFailOffset + Speed\_Level \times 1 dB$$

wherein connEstFailCount, connEstFailOffsetValidity, and connEstFailOffset are parameters defined by the 3GPP specifications. The configuration parameter connEstFailCount_Final specifies a failure count threshold, indicating the number of consecutive connection establishment failures that may trigger further actions. The configuration parameter connEstFailOffsetValidity_Final defines a validity duration during which an offset remains effective once a connection failure is detected. The configuration parameter connEstFailOffset_Final represents the offset value to be applied in cell reselection or prioritization, thereby reducing the likelihood that a cell associated with repeated failures will be selected again within the validity duration. As shown above, the UE may adjust the configuration parameters, connEstFailCount_Final, connEstFailOffsetValidity_Final, and connEstFailOffset_Final, by Speed_Level×0.2, (1−Speed_Level×0.05), and Speed_Level×1 dB in the formula, respectively. For example, by means of such adjustment, the value of connEstFailCount_Final may be decreased as the speed of the UE increases, so as to reduce the number of connection establishment attempts performed by the UE.

As described above, the method and apparatus for dynamically adjusting configuration parameters proposed in the present disclosure use pre-defined speed levels and their corresponding configurations to improve adaptability for the UEs, thereby enhancing interoperability with the network under different mobility conditions. By dynamically adjusting configuration parameters in accordance with the speed level of the UE, the system may achieve improved service quality (e.g., higher throughput, lower latency, and improved mean opinion score (MOS)) as well as enhanced service continuity (e.g., increased in-service rate and mobile terminated (MT) success rate). Thus, the proposed approach ensures more reliable and efficient operation across various mobility scenarios.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for dynamically adjusting configuration parameters, wherein the method is implemented by a user equipment (UE), and comprises:
obtaining a current absolute speed of the UE according to current speed information;
obtaining a speed level corresponding to the current absolute speed; and
adjusting at least one configuration parameter according to the speed level.

2. The method for dynamically adjusting configuration parameters as claimed in claim 1, further comprising:
performing a network access procedure according to the at least one adjusted configuration parameter.

3. The method for dynamically adjusting configuration parameters as claimed in claim 1, further comprising:
obtaining historical speed information in an event that the current speed information is unavailable; and
inferring the current absolute speed according to the historical speed information.

4. The method for dynamically adjusting configuration parameters as claimed in claim 3, wherein the inferring of the current absolute speed according to the historical speed information further comprises:
determining an average or a weighted average of the historical speed information as the current absolute speed.

5. The method for dynamically adjusting configuration parameters as claimed in claim 3, wherein the inferring of the current absolute speed according to the historical speed information further comprises:
training a machine learning model on the historical speed information; and
using the machine learning model to infer the current absolute speed automatically.

6. The method for dynamically adjusting configuration parameters as claimed in claim 1, wherein ranges of the current absolute speed corresponding to respective speed levels are non-uniform.

7. The method for dynamically adjusting configuration parameters as claimed in claim 1, wherein the at least one configuration parameter comprises one of a random access (RA) retry time, a time-to-trigger (TTT) timer, a cell (re)selection parameter, and a reselection threshold.

8. The method for dynamically adjusting configuration parameters as claimed in claim 1, wherein the at least one configuration parameter is given by a network node and is a variable value.

9. The method for dynamically adjusting configuration parameters as claimed in claim 1, wherein the at least one configuration parameter is given by a wireless communication standard and is a fixed value.

10. The method for dynamically adjusting configuration parameters as claimed in claim 1, wherein the at least one configuration parameter is adjusted while the UE is in an IDLE state, an INACTIVE state, or a CONNECTED state.

11. An apparatus for dynamically adjusting configuration parameters, comprising:
a transceiver which, during operation, wirelessly communicates; and
a processor communicatively coupled to the transceiver such that, during operation, the processor performs operations comprising:
obtaining a current absolute speed of the apparatus according to current speed information;
obtaining a speed level corresponding to the current absolute; and
adjusting at least one configuration parameter according to the speed level.

12. The apparatus for dynamically adjusting configuration parameters as claimed in claim 11, wherein the processor is further configured to perform operations comprising:
performing a network access procedure according to the at least one adjusted configuration parameter.

13. The apparatus for dynamically adjusting configuration parameters as claimed in claim 11, wherein the processor is further configured to perform operations comprising:
obtaining historical speed information in an event that the current speed information is unavailable; and
inferring the current absolute speed according to the historical speed information.

14. The apparatus for dynamically adjusting configuration parameters as claimed in claim 13, wherein in inferring the current absolute speed according to the historical speed information, the processor is further configured to perform operations comprising:
determining an average or a weighted average of the historical speed information as the current absolute speed.

15. The apparatus for dynamically adjusting configuration parameters as claimed in claim 13, wherein, in inferring the current absolute speed according to the historical speed information, the processor is further configured to perform operations comprising:
training a machine learning model on the historical speed information; and
using the machine learning model to infer the current absolute speed automatically.

16. The apparatus for dynamically adjusting configuration parameters as claimed in claim 11, wherein ranges of the current absolute speed corresponding to respective speed levels are non-uniform.

17. The apparatus for dynamically adjusting configuration parameters as claimed in claim 11, wherein the at least one configuration parameter comprises one of a random access (RA) retry time, a time-to-trigger (TTT) timer, a cell (re)selection parameter, and a reselection threshold.

18. The apparatus for dynamically adjusting configuration parameters as claimed in claim 11, wherein the at least one configuration parameter is given by a network node and is a variable value.

19. The apparatus for dynamically adjusting configuration parameters as claimed in claim 11, wherein the at least one configuration parameter is given by a wireless communication standard and is a fixed value.

20. The apparatus for dynamically adjusting configuration parameters as claimed in claim 11, wherein the at least one configuration parameter is adjusted while the apparatus is in an IDLE state, an INACTIVE state, or a CONNECTED state.
